(19) United States
(12) Patent Application Publication
(10) Pub. No.: US 2013/0013398 A1
(43) Pub. Date: Jan. 10, 2013

(54) MARKETING AND SHOPPING METHOD VIA INTERNET

(76) Inventor: Cheng-Sung WEI, Taipei (TW)

(21) Appl. No.: 13/179,101

(22) Filed: Jul. 8, 2011

(51) Int. Cl. G06Q 30/00

(52) U.S. Cl. 705/14.49

(57) ABSTRACT

This invention provides a as a marketing and shopping method via Internet, including providing a web server, providing a correlating database, providing an event code database, providing a consumer viewing page, providing a marketing page and providing a shopping page. By the above method, the users can acknowledge whether what they would like to buy or attend has be bought or is about to be bought by friends, and accordingly consider if they are going to make a buying decision.

### BACKGROUND OF THE INVENTION

1. Field of the Invention

The present invention relates to a marketing and shopping method via Internet, and particularly, to a marketing and shopping method through which the users can acknowledge what friends would like to buy or as their reference when buying or inviting friends to buy together.

2. Description of Related Art

Today's online trading environment is becoming increasingly easy. Different types of trading platforms continue to emerge, such as auction sites, shopping sites, group buying, etc. The user can freely, without any limit in time or space, go shopping online.

The convenience of online trading is generally difficult to be replaced by physical store transactions. Parity over Internet is easy and it has no need to compare prices store to store, but only to collect information over a network, parity can be completed quickly. Furthermore, In addition, because the online stores need not pay rent like physical stores, they can offer more favorable product price which is in favor of customers.

However, the shopping is limited to the purchase behaviors of the users themselves, or make purchases through the site settings with other users at the same time for shopping (i.e., group buying, without knowing the identities of the other users). In other words, each user, during the shopping, can only be considered on his or her own preferences, but not from the shopping platform if he or she also would like to know whether anyone else has the same interest in buying the same goods.

Therefore, there is a need of a novel marketing and shopping method via Internet which overcomes the above disadvantages of riding safety.

### SUMMARY OF THE INVENTION

The object of the present invention is to provide a marketing and shopping method through which the users can acknowledge what friends would like to buy and accordingly takes it as one of their references.

A marketing and shopping method via Internet, including providing a web server; providing a correlating database; providing an event code database; providing a consumer viewing page; providing a marketing page; and providing a shopping page.

The web server allows the users to go online via Internet. The correlating database is stored in the web server and used to access the data of relationship between the various users. The event code database is stored in the web server, and used to access the data of information of all goods or sale promotions. The consumer viewing page is stored in the web server and used to display the information of all goods or sale promotions for users to choose which they would like to purchase or what sale promotions they would like to join. The marketing page is stored in the web server, and used to display what the user's friends would like to buy or which sale promotions the user's friends would like to join. The shopping page is stored in the web server, and used for the users to make their purchase.

By using the above method, the users can acknowledge what friends would like to buy and accordingly takes it as one of their references. Therefore, this invention can offer for purposes of users' shopping and commercial marketing.

In this invention, the dates of friends' birthdays can be offered, and what they bought or what they would like to buy can be made in sequence at the basis of the dates of the friends' birthdays for users' references.

Another aspect of the invention is to allow the users to buy friends' gifts according to what the friends bought or which sale promotions their friends attended.

Another aspect of the invention is to provide an analysis report which indicates to the retailers the amount of to-be-sold products so as to reduce the amount of the in-stock products and increase the flexibility of delivery.

Another aspect of the invention is to analyze the user's buying capability and habit for the reference to various sale promotions.

Another aspect of the invention is to allow the user to optionally trace what they bought or which sale promotions they attended and share their using experience.

Another aspect of the invention is to allow the users to recommend what they bought or which sale promotions they attended so that the friends can acknowledge what the users bought or which sale promotions they attended. Furthermore, according to the buying records of the friends' purchases, the relevant feedback is proceeded.

Still another aspect of the invention is to open the users' purchases to other social networking sites.

In order to further the understanding regarding the present invention, the following embodiments are provided along with illustrations to facilitate the disclosure of the present invention.

### BRIEF DESCRIPTION OF THE DRAWINGS

FIG. 1 is a schematic view of a marketing and shopping method according to one embodiment of the invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended tables.

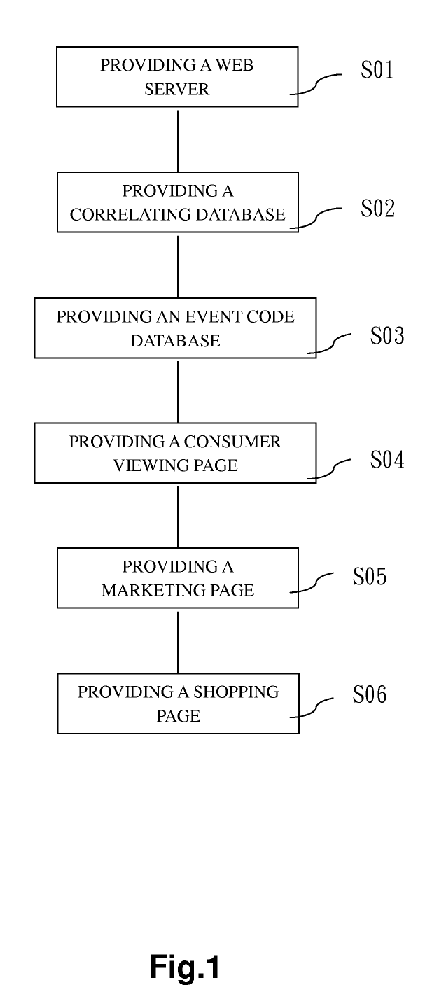

FIG. 1 shows a marketing and shopping method via Internet according to one embodiment of the invention. The method includes the following steps: providing a web server S01, providing a correlating database S02, providing an event code database S03, providing a consumer viewing page S04, providing a marketing page S05 and providing a shopping page S06. The correlation database, the event code database, the consumer viewing page, the marketing page and the shopping page are all stored in the web server.

The web server is provided for a plurality of users to go online via the internet. The correlation database is used to access the data of the relationship between the various users. The event code database is used to access the data of information of all goods or sale promotions. The consumer viewing page is used to display the information of all goods or sale promotions for users to choose which they would like to purchase or what sale promotions they would like to join. The marketing page is stored in the web server and used to display what the user's friends would like to buy or which sale promotions the user's friends would like to join. The shopping page is stored in the web server and used for the users to make their online purchase.

In such a way, the user can refer to what their friends buy or which sale promotion they join, and accordingly makes a buying decision. To increase the user's confidence in buying is also a kind of marketing way. Alternately, the user can join a group buying by gathering all who are interested in the same product with a lower price.

In the marketing page, friends' birthday dates can be the consequence basis so that the most upcoming date among them can be in the first consequence of data as the user's reference basis. The marketing page further offers a purchasing mechanism for community gifts, asking the user's friends to purchase what the user is buying or which sale promotions the user is participating. As what is listed for buying or joining is what the user is interested, the user's friends will be easy to know what the user likes as a gift for him or her. Through this service, people will be delighted what will receive and expect the gift receiver to be glad when the gift arrives.

This embodiment further provides an analysis unit in the web server. According to what the users would like to buy or which sale promotions the users would like to join, the required amount of each product or the number of attendants in each sale promotion is analyzed so that the quality in stock can be adjusted to achieve higher flexibility of delivery. Furthermore, the analysis unit can further analyze each user each user's shopping habit and capability. The analysis result can be a reference for planning other events or sending proper messages about sale promotions to the users.

In this embodiment, a product favoring unit is further provided for a corresponding product. The product favoring unit is stored in the web server. After the users finish the shopping, they can be optionally added as fans of that purchased product so that the updated status of that purchased product can be traced or the users can share their using experience. In order to confirm the users as fans are the real purchasers, they will be asked to register which needs to provide the product series number, invoice number and any other required information.

In this embodiment, a recommending unit in the web server is further provided. When the user is making a purchase, the same type of goods can be recommended to other users as relevant information to the records. Meanwhile, a feedback unit can be further used in the web server to feedback, according to those whom the same product is recommended to, something useful, such as cumulative number of points or money, thereby inspiring the users to buying more.

This embodiment further provides a social networking sites connecting unit in the web server to connect to other social networking sites. Thereby, the users can optionally open on other social networking sites the products or services they bought so as to persuade their friends of the results.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A marketing and shopping method via Internet, comprising:
providing a web server through which users go online via Internet;
providing a correlating database stored in the web server, used to access the data of relationship between the various users;
providing an event code database stored in the web server, used to access the data of information of all goods or sale promotions;
providing a consumer viewing page stored in the web server, used to display the information of all goods or sale promotions for users to choose which they would like to purchase or what sale promotions they would like to join;
providing a marketing page stored in the web server, used to display what the user's friends would like to buy or which sale promotions the user's friends would like to join; and
providing a shopping page stored in the web server, used for the users to make their purchase.

2. The method of claim 1, wherein in the marketing page, friends' birthday dates can be the consequence basis so that the most upcoming date among them can be in the first consequence of data as the user's reference basis.

3. The method of claim 2, wherein the marketing page further offers a purchasing mechanism for community gifts, asking the user's friends to purchase what the user is buying or which sale promotions the user is participating.

4. The method of claim 1, further providing an analysis unit in the web server, wherein according to what the users would like to buy or which sale promotions the users would like to join, the required amount of each product or the number of attendants in each sale promotion is analyzed.

5. The method of claim 4, wherein the analysis unit can further analyze each user each user's shopping habit and capability.

6. The method of claim 1, wherein a product favoring unit is further provided for a corresponding product, and is stored in the web server.

7. The method of claim 1, wherein a recommending unit in the web server is further provided. When the user is making a purchase, the same type of goods can be recommended to other users.

8. The method of claim 7, wherein a feedback unit is further provided in the web server to feedback according to those whom the same product is recommended to.

9. The method of claim 1, wherein a social networking sites connecting unit in the web server to connect to other social networking sites.
